(19) United States
(12) Patent Application Publication
(10) Pub. No.: US 2014/0262402 A1
(43) Pub. Date: Sep. 18, 2014

(54) Power Hand Tool with Vibration Isolation

(71) Applicants: Robert Bosch GmbH, Stuttgart (DE); Robert Bosch Tool Corporation, Broadview, IL (US)

(72) Inventors: Brian Kenneth Haman, Chicago, IL (US); Hector Ruiz, Westmont, IL (US); Stephen C. Oberheim, Des Plaines, IL (US); David Pozgay, Evanston, IL (US)

(73) Assignee: Robert Bosch GmbH, Stuttgart (DE)

(21) Appl. No.: 14/208,531

(22) Filed: Mar. 13, 2014

Related U.S. Application Data
(60) Provisional application No. 61/784,186, filed on Mar. 14, 2013.
(60) Provisional application No. 61/806,289, filed on Mar. 28, 2013.

(51) Int. Cl. B25F 5/00

(52) U.S. Cl. CPC B25F 5/006
USPC 173/162.2

(57) ABSTRACT

In one embodiment, a power hand tool includes a housing containing a working shaft, and a vibration isolation assembly, the vibration isolation assembly including at least one base member including a base portion fixed with respect to the housing, at least one vibration isolation portion including a first portion operably connected to the at least one base member, the at least one vibration isolation portion configured to isolate vibration in at least one direction, and a grip member having an outer surface configured to be gripped by a user and an inner surface operably connected to an outer portion of the at least one vibration isolation portion.

This application claims the benefit of U.S. Provisional Application No. 61/784,186 filed Mar. 14, 2013, and U.S. Provisional Application No. 61/806,289 filed Mar. 28, 2013, the entirety of which are both incorporated herein by reference.

### FIELD

This disclosure relates to power hand tools and more specifically to power hand tools which create vibration.

### BACKGROUND

Reciprocating tools that are motor driven, such as saber saws, larger reciprocating saws and the like are usually driven by electric motors that have a rotating output shaft. The rotating motion is translated into reciprocating motion of a working shaft for moving a saw blade or the like in a reciprocating manner. Various approaches have been developed which translate the rotational motion into reciprocating motion. A common approach is the incorporation of a wobble plate drive.

A “wobble plate” assembly is a configuration wherein a shaft has an angled portion on which an arm is mounted through a ball bearing assembly. The arm is slidingly positioned within a portion of a plunger assembly. As the angled portion of the shaft rotates, the arm translates the rotation of the shaft into a reciprocating movement of the plunger assembly. One example of a reciprocating tool which incorporates a wobble plate drive is U.S. Pat. No. 7,707,729, which issued on May 4, 2010, the entire contents of which are herein incorporated by reference.

As the working shaft of the plunger assembly moves along an axis, a significant amount of momentum is created. All of this momentum is absorbed by the tool as the plunger assembly reverses direction. Thus, a user of a reciprocating tool incorporating a wobble plate drive must contend with a powerfully vibrating device. In order to make such reciprocating tools more controllable, reciprocating tools such as the device in the '729 patent incorporate a counterweight which is driven by a secondary wobble plate in a direction opposite to the direction of the plunger assembly. While the incorporation of a secondary wobble plate and counterweight is effective, a user is still exposed to a significant amount of undesired vibration.

Other devices for changing rotational movement to reciprocating movement include scotch yoke mechanism and crank sliders. Such devices are disclosed in U.S. Pat. No. 6,357,125 which issued on Mar. 19, 2002, and U.S. Patent Publication No. 2008/0134855, which was published on Jun. 12, 2008, the entire contents of which are both herein incorporated by reference. These systems also suffer from undesired vibration.

In the field of rotary hammers, some effort has been made to reduce the vibrations experienced by a user by decoupling the handle from the tool. The isolators only isolate the handle from impacts in one direction. Since reciprocating saws have a large reciprocating mass that is accelerated and decelerated in both the forward and reverse direction, large vibration forces are generated in both the forward and reverse direction.

Some reciprocating saws have been developed which attempt to isolate the handle by trapping an isolating elastomer between the handle and the tool housing. A certain level of isolation has been achieved, but additional isolation is desired.

Other hand power tools also create vibrations which can be injurious to a user, particularly when the power tool is used over prolonged periods. Such tools include grinders, sanders, routers, and other rotary, oscillating, and reciprocating tools.

A need exists for a power hand tool which reduces vibration experienced by a user. A further need exists for a power hand tool which reduces vibration which does not rely upon bulky assemblies. A system which reduces vibrations in a power hand tool while reducing costs associated with vibration reduction would be further beneficial.

### SUMMARY

In one embodiment, a power hand tool includes a housing containing a working shaft, and a vibration isolation assembly, the vibration isolation assembly including at least one base member including a base portion fixed with respect to the housing, at least one vibration isolation portion including a first portion operably connected to the at least one base member, the at least one vibration isolation portion configured to isolate vibration in at least one direction, and a grip member having an outer surface configured to be gripped by a user and an inner surface operably connected to an outer portion of the at least one vibration isolation portion.

In another embodiment, a reciprocating tool provides improved vibration isolation by allowing for a greater amount of displacement of the vibrating tool with respect to the decoupled tool. Both the forward grip and the rear handle of a saw in one embodiment are provided with isolating mechanisms which isolate the grip/handle from forces occurring in both forward and rearward directions.

### BRIEF DESCRIPTION OF THE DRAWINGS

FIG. 1 depicts a side perspective view of a reciprocating tool incorporating a vibration isolation system in accordance with principles of the disclosure;

FIG. 2 depicts a side cross-sectional view of the isolation system of FIG. 1;

FIG. 3 depicts a side cross-sectional view of the isolation system of FIG. 1;

FIG. 4 depicts a bottom cross-sectional view of the isolation system of FIG. 1;

FIG. 5 depicts a side cross-sectional view of a vibration isolation system that can be used with the tool of FIG. 1;

FIG. 6 depicts a side cross-sectional view of a vibration isolation system that can be used with the tool of FIG. 1;

FIGS. 7-11 depict views of a vibration isolation system that can be used with the tool of FIG. 1 which incorporates elastomer pads;

FIGS. 12-15 depict views of a vibration isolation system that can be used with the tool of FIG. 1 which incorporates elastomer cylinders;

FIGS. 16-19 depict isolation systems incorporating isolators of different shapes and orientations to provide modified stiffness characteristics;

FIGS. 20-21 depicts an isolation system which includes differently shaped isolators to provide a varying stiffness depending upon the usage of the tool;

FIGS. 22-24 depict embodiments wherein an isolator is shaped in order to provide different stiffness characteristics by forming voids within the isolator;

FIGS. 25-28 depict an embodiment which includes press fit components for ease of construction;

FIGS. 29-30 depict an embodiment of an isolation system which traps isolator pads between two housing portions for ease of manufacturing;

FIGS. 31-32 depict an embodiment of an isolation system wherein an elastomeric pad is bonded to pieces of metal to form an assembly which is easily mounted to a tool housing;

FIGS. 33-34 depict an embodiment of an isolation system wherein an elastomeric pad is bonded to a sled housing on one side and a piece of metal on the other side to form an assembly which is easily mounted to a tool housing

FIGS. 35-36 depict an embodiment of an isolation system wherein an elastomeric pad is formed with locking tabs which are easily mounted to a sled housing

FIGS. 37-38 depict an embodiment of an isolation system wherein a port is formed in the sled and isolation pad to provide for dust removal capability;

FIG. 39 depicts an isolation system which includes a quick release button;

FIGS. 40-42 depict an isolation system that includes a button which allows the isolation system to be quickly activated/deactivated;

FIGS. 43-45 depict an embodiment of an isolation system wherein a used can easily adjust the stiffness of the system;

FIG. 46 depicts an embodiment of an isolation system wherein an elastomeric pad in the form of bars is formed on a tool housing and a rubber boot encloses the elastomer pad;

FIG. 47 depicts an embodiment of an isolation system wherein an elastomeric pad in the form of cylinders is formed on a tool housing and a rubber boot encloses the elastomer pad housing;

FIG. 48 depicts an embodiment of an isolation system which is formed as a one piece insert molded system;

FIG. 49 depicts an embodiment of an isolation system which includes thermal protection;

FIG. 50 depicts an embodiment of an isolation system wherein a rubber boot encloses the isolation system; and

FIGS. 51-54 show the isolation systems disclosed herein in use with various types of hand power tools.

### DESCRIPTION

For the purposes of promoting an understanding of the principles of the disclosure, reference will now be made to the embodiments illustrated in the drawings and described in the following written specification. It is understood that no limitation to the scope of the disclosure is thereby intended. It is further understood that the present disclosure includes any alterations and modifications to the illustrated embodiments and includes further applications of the principles of the disclosure as would normally occur to one skilled in the art to which this disclosure pertains.

FIG. 1 depicts a reciprocating saw 100 including an outer housing 102 which includes a handle portion 104, a motor portion 106, and a nose portion 108. The handle portion 104 includes a handle 112, a dual-speed switch 114, and a variable speed trigger 116. The handle portion 104 is configured to removably receive a battery pack 118 which in some embodiments is replaced by a corded power supply.

The nose portion 108 includes a grip 124 which includes an outer surface shaped to allow a user to grip the tool 100 while the tool 100 is in use. A foot plate assembly 120 is located forwardly of the nose portion 108.

The motor portion 106 includes a number of ventilation ports 122 which are used to provide cooling air to a motor (not shown). The motor (not shown) rotatably drives a wobble plate assembly (not shown) which in turn drives a working shaft connected to a chuck assembly (not shown) which removably supports a saw blade 126. The saw blade 126 is driven along a plunger axis 128 by the working shaft which reciprocates along the plunger axis 128.

The grip 124 includes a sled 140. The sled 140 is supported by the housing 102 by two base members in the form of pins 142/144 which are rigidly connected to the housing 102. The pins 142/144 extend through a respective rear washer supporting isolator 146/148 each of which is fixedly connected to a respective rear isolator 150/152.

The isolators 150/152 are positioned within a rear isolator cavity 154.

The pins 142/144 further extend through a respective one of a pair of support bushings 156/158 which are pressed into the sled 140. The support bushings 156/158 are positioned between the rear isolators 150/152 and a pair of front isolators 160/162. The front isolators 160/162 are located within a front cavity 168 of the sled 140. A pair of front washer supporting isolators 164/166 are fixedly attached to a respective one of the pins 142/144 at a location forward of the front isolators 160/162. These bushings 156/158 provide rigidity in to tool motion in both directions that are transverse to the front to back axis. This acts to prevent rocking of the tool body as well as increases control of the tool body during cutting. A front connector 170 extends between the pins 142/144 at a location between the front washer supporting isolators 164/166 and the front isolators 160/162. The front ends of the pins 142/144 are not attached to any other part of the reciprocating saw 100.

In operation, the reciprocating tool 100 generates vibrations along the plunger axis 128 as the working shaft reciprocates. The vibrations are isolated, however, by the grip 124. Specifically, as the tool 100 moves in the direction of the arrow 180 of FIGS. 1 and 4, the sled 124 does not initially move since the sled 124 is not fixedly connected to the housing 102 in which the working shaft reciprocates. The housing 102 thus pushes against the rear washer supporting isolators 146/148. Movement of the rear washer supporting isolators 146/148 generates a force against the rear isolators 150/152. The rear isolators 150/152 are made of an elastomer, a spring, or the like. Elastomers provide a given spring rate but also have a damping value which allows for a certain level of energy dissipation and is well suited for eliminating/reducing the chances of vibration amplification at the speeds at which the reciprocating saw 100 operates. Various springs also have a range of damping characteristics which can eliminate/reduce the chances of vibration amplification.

Consequently, the rear isolators 150/152 absorb a desired amount of the energy of the vibration, and also reduce the movement of the grip 124 in the direction of the arrow 180. Depending upon the particular embodiment, the housing 102 may begin to move in a direction opposite to the arrow 180 prior to movement of the sled in the direction of the arrow 180.

Once the reciprocating tool 100 reaches the end of a stroke and begins to move in the direction opposite to the arrow 180, the pins 142/144 move rearwardly with respect to the sled 140. The rearward movement of the pins 142/144 forces the front washer supporting isolators 164/166 against the front connector 170 which in turn presses against the front isolators 160/162. The front isolators 160/162 are also made of an elastomer, a spring, or the like. Accordingly, as the front connector 170 presses against the front isolators 160/162, the front isolators 160/162 compress, thereby absorbing the desired amount of energy of the vibration, and also reducing the movement of the grip 124 in the direction opposite to the arrow 180. The front connector 170 spreads the force more evenly across the front isolators 160/162 even in situations where the load is generated more heavily on one side of the grip.

The net effect of this isolated system is that it allows the tool to vibrate back and forth but the pin—bushing—isolator system decouples the user's hands from the vibration in axis of the pins. While the isolation system in the embodiment of FIG. 1 was described with respect to the grip, in some embodiments the isolation system is alternatively or additionally incorporated into the handle 112.

One or both of the grip/handle isolation systems in different embodiments may be modified for a particular application. By way of example, FIG. 5 depicts another isolator that in different embodiments is incorporated into one or both of the grip and handle of FIG. 1. The isolation system 200 of FIG. 5 includes a sled 202 which is spaced apart from a housing 204. A pin 206 is fixedly attached to the housing 204 and to a front and rear snap rings 208 and 210, respectively. The snap rings 208 and 210 are separated from an isolator 212 by a pair of washers 214/216. The pin 206 slidingly engages a support bushing 218 which is press-fit within the sled 202. These bushings 218 provide rigidity in to tool motion in both directions that are transverse to the front to back axis. This acts to prevent rocking of the tool body as well as increases control of the tool body during cutting.

The snap rings 208 and 210 on the pin 206 push/pull the washers 214/216, which in turn acts to compress the isolator 212 in response to the vibrating movement of the pin 206. In this embodiment, one less isolator is needed on each pin as compared to the embodiment of FIG. 1. While only a single pin 206 is depicted in FIG. 5, more pins may be present in the system.

Additionally, while FIGS. 1 and 5 depict grips which extend about the plunge axis, the isolators can also be used to isolate two ends of, for example, the handle 112. Thus, isolators are readily employed in both grips and handles.

In some embodiments, the “stiffness” of the isolating system can be modified. FIG. 6 depicts an isolation system 250 which includes a set screw 252 in a threaded end portion 254 of a pin 256. The set screw 252 can be used to modify the compression on the isolators 258/260 to provide a desired amount of vibration isolation of the sled 262.

FIGS. 7-11 depict a vibrations isolation system 300 which includes an outer elastomer sled 302 and, in this embodiment, a pair of inner elastomer pads 304. In other embodiments, springs are used in place of the elastomer pads 304. The elastomer sled and pads/springs provide three axes of vibration isolation. In the front-to-back direction the system provides shear loading of the pads/springs. In the side-to-side direction, the system provides compressive/tensile loading of the pads/springs. Finally, in the up-down direction, the system provides shear loading of the pads/springs.

While the outer elastomer sled 302 is depicted as generally rectangular, in other embodiments the sled has a more contoured shape, such as the shape of the sled in the grip 124. The pads 304 are also contoured to fit within the sled. In embodiments incorporating springs, the spring dimensions are selected to fit within the sled. The dimensions, durometer, and damping properties of the elastomer pads/springs and sled are selected in order to minimize vibration being passed on from the tool to the user's hands.

FIGS. 12-15 depict a vibrations isolation system 400 which includes an outer elastomer sled 402. The sled 402 rides upon four isolators 404, 406, 408, and 410 which may be elastomer cylindrical tubes or springs. The isolators 404/408 are supported by a pin 412 while the isolators 406/410 are supported by a pin 414. The pin 412 is rigidly connected to the housing within a receptacle 418 and the pin 414 is rigidly connected to the housing within a receptacle 420.

The elastomer sled 402 and isolators provide three axes of vibration isolation. In the front-to-back direction the system provides shear loading of the isolators. In the side-to-side direction, the system provides compressive/tensile loading of the isolators. Finally, in the up-down direction, the system provides shear loading of the isolators. The dimensions, durometer, and damping properties of the elastomer tubes/springs and sled are selected in order to minimize vibration being passed on from the tool to the user's hands.

The amount of vibration isolation in a particular implementation is optimized in various manners. Vibration isolation is optimized by way of a combination of material properties and geometries. For example, the stiffness provided by the elastomer pad 304 in FIG. 8 can be modified by selecting, for a given size and shape of the pad 304, a material which provides the desired stiffness. For a given material, stiffness can be modified by increasing or decreasing the dimensions of the material (length, width, and thickness).

FIG. 16 depicts a power hand tool 450 which is similar to the power hand tool on which the pad 304 is mounted. The pad 452 which is used in the power hand tool 450 is made from the same material as the pad 304. The stiffness of the pad 452 is modified, however, since the pad 452 is embodied as a group of bars 454. The bars 454 are oriented such that the stiffness of the pad 452 along the axis 456 is much less than the stiffness of the pad 304, while the stiffness of the pad 452 along the axis 458 is only slightly less than the stiffness of the pad 304.

By modifying the size and numbers of the elastomeric bars 452, the stiffness characteristics can be further modified. By way of example, the pad 460 in FIG. 17 includes stiffening components in the form of bars 462 which are thinner than the bars 452, thus modifying the stiffness of the pad 460. The pad 464 in FIG. 18 includes stiffening components in the form of elastomeric bars 466 which have been oriented to provide enhanced stiffness along the axis 468. Thus, the orientation of the pad can be modified to provide the desired stiffness characteristics.

In some embodiments, it may be desired to have reduced stiffness along two axes of the power hand tool. FIG. 19 depicts an elastomeric pad 470 which is constructed with a group stiffening components in the form of cylinders 472. The cylinders reduce the stiffness along all axes of the tool, allowing an overly stiff elastomer to be used without maintaining a high stiffness in the pad 470.

Additional stiffness optimization is realized in some embodiments by providing multiple geometries of stiffening components within a single pad. By way of example, FIGS. 20-21 depict an elastomeric pad 474 positioned between a sled 476 and a housing 478 of a power hand tool. The pad 474 includes connecting bars 480 and truncated bars 482. Each of the truncated bars 482 is located between a connecting bar 480 and a stiffening rib 484 of the housing 478.

The embodiment of FIGS. 20-21 provide varying isolator pad 474 geometry for a shear loaded system that allows for progressively stiffening the elastomer pad 474 upon larger deflections. Small deflections of the system result in a stiffness defined only by one set of pads, the connector pads 480, which provides a very loose (non-stiff) system. Larger deflections lead to the connector pads 480 bottoming out on the truncated bars 482 thereby increasing the stiffness of the system. After reaching a certain deflection, the pads 480 and 482 bottom out on the rigid metal ribs 484 and the system becomes significantly more stiff. This progressive increase in stiffness limits the user's looseness of the handle when high loads are applied while still allowing for ideal isolation properties under low loads.

The embodiment of FIGS. 20-21 functions in a similar manner in compression. In cases of small displacements, the connector pads 480 are the only isolator set compressing. Larger displacements leads to the sled 476, which in one embodiment is a metal plate, coming into contact with the truncated bars 482 and thus stiffening the system. Under even larger displacements, the sled 476 comes in contact with the rigid metal ribs 484 and rigidly bottoms out preventing additional displacement. This embodiment thus shows a progressively stiffening isolation system on a power hand tool.

The use of different geometries or shape factors can also be used with isolation systems similar to the isolation system of FIGS. 12-15. By way of example, FIG. 22 depicts a vibrations isolation system 490 which includes an outer elastomer sled 492. The sled 402 rides upon two elastomer cylindrical tubes 494 and 496. The elastomer cylindrical tube 494 is slidingly supported by a pin 498 while the elastomer cylindrical tube 496 is slidingly supported by a pin 500. The pin 494 is rigidly connected to the housing within a receptacle 502 and the pin 496 is rigidly connected to the housing within a receptacle 504.

The isolation system 510 of FIG. 23 is substantially the same as the isolation system 490 of FIG. 22. The difference is that the elastomer cylindrical tubes 512/514 include a plurality of bores 516. The bores 516 modify the stiffness longitudinally and radially. The positioning of the bores 516 and the surrounding structure determine the extent of the modification radially and longitudinally. For example, the tubes 512/514 are configured in one embodiment to spread an applied load evenly across the ends of the cylinders. Thus, the location of the bores 516 is less important as compared to the number of bores. Radially, however, the manner in which force is transferred about the bores 516 is dependent upon the positioning of the bores 516.

FIG. 24 depicts an isolation system 520 which is similar to the system 510 of FIG. 23. The main difference is that additional stiffness modification is accomplished by providing an increased number of bores 522 through the elastomer cylindrical tubes 524/526.

While various embodiments of isolation systems have been depicted above, the principles set forth in each of the specific embodiments are incorporated in different combinations in other embodiments. Additional modifications are also possible so as to provide additional benefits for particular embodiments. Thus, additional components may be added to ease manufacturing. FIGS. 25-28, for example, depict an isolation system 530 which includes a sled supported by two pins 532/534 which are attached to a housing 536. Two elastomer cylinders 538/540 are bonded to the pins 532/534 and each cylinder 538/540 has a tube 542/544 bonded to its outer diameter.

During manufacturing, the elastomer cylinders 538/540 are bonded to the pins 532/534 on the inner diameter of the elastomer cylinders. The isolator then has a tube 542/544 bonded to its outer diameter. This method of manufacturing facilitates production assembly of the sled system. A press fit of the pins 532/534 to the housing and a press fit of the metal tube to corresponding bores in the anti-vibration handle allow the system to be secured in a decoupled fashion through the isolators.

The above described embodiments can be manufactured in a variety of processes. In different embodiments, the location and quantity of tubeform isolators is varied, and the location and quantity of isolator pads is varied as well. For example, while several embodiments showing tubes in an “over/under” configuration have been shown, other combinations and positioning of the tubes are incorporated in other embodiments.

Similarly, some of the above described embodiments depict two isolator pads, one located on the left and one located on the right side of the output shaft. In other embodiments, other combinations and positioning of the pads are incorporated. One such embodiment has pads located above and below the shaft, and another embodiment has three or four pads located equidistant about the shaft.

To facilitate manufacture of some embodiments, a clamshell sled is used. FIGS. 29-30 depict an isolation system including two housings 550/552 which, when fastened together, effectively trap isolator pads 554/556 between the sled housings 550/552 and the housing 558 of the power tool.

In some embodiments, an elastomer pad 560 (see FIG. 31) is bonded to pieces of metal 562/564. This subassembly is easily assembled in an anti-vibration handle 566 such as by mating with corresponding pockets/recesses 568/570 in the handle and housing to rigidly link the metal pads to the housing and handle while still allowing for the decoupling of the handle from the tool itself as shown in FIG. 32.

In another embodiment (see FIG. 33), an elastomer pad 572 is directly molded onto the sled/handle housing 574 on one side of the elastomer and bonded to a metal pad 576 on the other side of the elastomer pad 572 to assist in assembling the handle to the power tool housing as depicted in FIG. 34.

FIGS. 35-36 depict an embodiment which does not require bonding. The elastomer pads 580 are formed with securing tabs 582. When the elastomer pads 580 are inserted in the housing 584, the protruding tabs 582 lock in the undercut portion of the housing & handle 584. While one geometry of locking tabs is depicted, other geometries are used in other embodiments.

The above described embodiments are modified to provide for additional functionality in some embodiments. FIGS. 37 and 38 depict an isolation system 590 that is modified to provide a port through which a dust removal hose 592 draws a suction. The isolation system 590 in some embodiments is modified in shape and location to optimize collection of dust, such as by enclosing the blade holder and a portion of the blade in a portion of the tool housing or housing of the isolation system 590.

While some of the clamshell embodiments depicted above include a screw or threaded fastener to attach the clamshells together, some embodiments provide for a quick release mechanism. FIG. 39 depicts an isolation system 596 which includes a quick-release button 598 which provides the user with a method for quickly removing the front handle/isolation system 596. This embodiment is desirable for situations where the user is working in tight areas that the front handle may be preventing the user from being able to access.

FIGS. 40-41 depict an isolation system 600 which includes an activation button 602 which provides the user with a method for quickly activating/deactivating the handle/isolation system 600. This embodiment is desirable for situations where the user does not desire to have the decoupled front handle/system (vibration isolated handle) 600. The activation button 602 can be engaged/disengaged to switch between coupled handle (no anti-vibration as in FIG. 42) and decoupled handle (isolators are loaded and anti-vibration system is engaged as in FIG. 41).

In the above described embodiments, a further modification is to make the stiffness of the system user changeable. By way of example, FIGS. 43-45 depict an isolation system 610 that includes levers 612. By moving the levers between the full isolation position of FIG. 44 and the reduced isolation configuration of FIG. 45, the stiffness of the system 610 is increased by reducing the effectiveness of the elastomer pads 614 by pressing the ends 616 of the levers 612 into the pads 614. This variable pre-compression will drive the system stiffness and thus the system's isolation efficiency.

The above described embodiments may further be modified to present a lower profile of the vibration isolation system. For example, many of the above described embodiments depict the vibration isolation system as a forward handle or grip that is positioned about the tool housing. FIG. 46 depicts a vibration isolation system 620 which includes rubber or elastomer ribs 622 molded onto a metal housing 624 of the tool. A rubber boot 626 is also molded onto the housing 624 at a posterior portion of the boot 626. The anterior portion of the boot 626 interacts with the ribs 622 to provide vibration isolation. The rubber boot 626 acts as a ‘skin’ of sorts allowing the user to grip onto it but also allowing the rubber ribs 622 to translate during shear loading of them (front to back vibration) as well as bend during compressive loading (side to side/up down). The rubber boot in some embodiments is configured to allow air to move between the boot and the housing for cooling and/or debris removal.

In some embodiments, ribs are formed additionally or alternatively on the boot 626. In some embodiments, the ribs are formed on the exterior of the boot 626 and are directly contacted by the user's hands. Moreover, while the ribs 626 are shown in the form of bars, the shape and spacing may be modified in accordance with the various embodiments described above. For example, FIG. 47 depicts a vibration isolation system 630 that incorporates a pattern of cylinders 632 that are molded to the metal housing 634. The cylinders 632 could additionally or alternatively be molded to the inside or outside of the boot 636.

As can be seen in FIG. 47, there is an air gap 638 between the metal front housing 634 and the boot 636. The boot in this embodiment includes a number of vent holes 640. By molding or otherwise forming vent holes in this area of the exterior boot, the front housing 634 can benefit from convection by means of cool air being allowed to pass over and in contact with the front housing 634. This differs from existing front ends where the boot covers the majority of the front housing surface in order to ensure the user is isolated from the heat generated in the mechanism. With the larger gap 638, vents 640 can be incorporated without the threat of the user injuring themselves due to incidental contact with the hot metal front housing.

FIG. 48 depicts an isolator system 650 which uses a one piece multiple insert molding operation that combines a rigid Nylon grip surface 652, isolation material, 654, and in some embodiments, includes rubber boot material 656. The isolation material 654 traps the rigid nylon grip surface 652. This allows the user to grab onto a firm surface while still achieving three axes of vibration isolation. The isolation material 654 can then also be bonded to a traditional rubber boot material to make a one piece assembly onto the front housing of the tool, if desired.

Yet another modification that is incorporated into various of the above described embodiments is shown in FIG. 49. During operation, heat is generated in hand power tools. This heat can negatively affect the performance values of the elastomer (stiffness, damping, etc.) and therefore negatively affect the isolation efficiency of the system. Because of this, in some embodiments this heat transfer is mitigated. Thus, FIG. 49 shows elastomer pads 660 with the thermal barriers 662 located on either side of the elastomer pad 660. In different embodiments, thermal barriers 662 are located on both sides of the isolator, or just on the inside surface to minimize the heat transfer to the elastomer from the tool mechanism.

In some of the above described embodiments, a secondary front handle isolated a user from the tool vibrations. Thus, the user would be holding onto this secondary handle from the exterior. The above described embodiments in some instances are modified by wrapping a rubber boot around both the metal front housing and isolated handle in order to achieve a more aesthetically pleasing appearance. By way of example, FIG. 50 depicts an isolation system 670 which is enclosed by a boot 672. The rubber boot 672 flexes in accordance with the relative movements between the metal front housing 674 and the front handle 670.

The above described isolation systems have been depicted primarily in use with reciprocating tools. The systems can be used, however, with any desired hand power tool. Thus, FIG. 51 shows an isolation system 680 used with a drill, FIG. 52 shows an isolation system 682 used with an oscillating tool, FIG. 53 shows an isolation system 684 used with a router, and FIG. 54 shows an isolation system 686 used with a grinder. Moreover, while typically a single isolation system has been depicted in connection with a particular tool, in some embodiments multiple isolation systems are incorporated, some of which may be different from other incorporated isolation systems.

While the disclosure has been illustrated and described in detail in the drawings and foregoing description, the same should be considered as illustrative and not restrictive in character. It is understood that only the preferred embodiments have been presented and that all changes, modifications and further applications that come within the spirit of the disclosure are desired to be protected.

1. A power hand tool, comprising:
a housing containing a working shaft; and
a vibration isolation assembly, the vibration isolation assembly including
at least one base member including a base portion fixed with respect to the housing,
at least one vibration isolation portion including a first portion operably connected to the at least one base member, the at least one vibration isolation portion configured to isolate vibration in at least one direction, and
a grip member having an outer surface configured to be gripped by a user and an inner surface operably connected to an outer portion of the at least one vibration isolation portion.

2. The power hand tool of claim 1, wherein:
the at least one base member comprises at least one pin having a first end fixedly supported by the housing;
the at least one vibration isolation portion comprises at least one isolator configured to oppose movement of the at least one pin forwardly and rearwardly along a working shaft axis; and
the grip member is operably connected to an outer radial surface of the at least one isolator.

3. The power hand tool of claim 2, further comprising:
a first member fixedly supported by the at least one pin and configured to act upon a first side of the at least one isolator as the at least one pin moves forwardly along the working shaft axis; and
a second member fixedly supported by the at least one pin and configured to act upon a second side of the at least one isolator as the at least one pin moves rearwardly along the working shaft axis.

4. The power hand tool of claim 3, wherein the at least one isolator consists of a single isolator.

5. The power hand tool of claim 4, wherein the single isolator comprises a spring.

6. The power hand tool of claim 3, further comprising:
at least one set screw configured to modify compression of the at least one isolator.

7. The power hand tool of claim 3, wherein:
the at least one isolator comprises a first and a second isolator axially aligned along the working shaft axis;
the first member is configured to act upon a rearward side of the first isolator as the at least one pin moves forwardly along the working shaft axis; and
the second member is configured to act upon a forward side of the second isolator as the at least one pin moves rearwardly along the working shaft axis.

8. The power hand tool of claim 1, wherein:
the at least one base member comprises at least one pin having a first end fixedly supported by the housing;
the at least one vibration isolation portion comprises at least one elastomer tube positioned about the at least one pin; and
the grip member is operably connected to an outer radial surface portion of the at least one at least one elastomer tube.

9. The power hand tool of claim 8, wherein:
an inner surface of the at least one elastomer tube extends about the at least one pin; and
at least one bore extends within the at least one elastomer tube between the inner surface and the outer radial surface portion.

10. The power hand tool of claim 8, wherein:
the at least one elastomer tube is bonded to the at least one pin;
a tube is bonded to the outer radial surface portion;
the at least one pin is press-fit into the housing; and
the tube is press-fit into a receiving bore in the grip member.

11. The power hand tool of claim 1, wherein:
the at least one base member comprises at least one elastomer pad; and
the at least one vibration isolation portion comprises a portion of the at least one elastomer pad located radially outwardly of the base portion.

12. The power hand tool of claim 11, wherein the at least one elastomer pad comprises:
a plurality of elastomer bars, each of the plurality of elastomer bars extending lengthwise along the working shaft axis.

13. The power hand tool of claim 11, wherein the at least one elastomer pad comprises:
a plurality of elastomer bars, each of the plurality of elastomer bars extending lengthwise in a non-parallel direction to the working shaft axis.

14. The power hand tool of claim 11, wherein the at least one elastomer pad comprises:
a plurality of elastomer cylinders, each of the plurality of elastomer cylinders extending lengthwise generally away from the working shaft axis.

15. The power hand tool of claim 11, wherein the at least one elastomer pad comprises:
a first plurality of bars, each of the first plurality of bars having a first end portion operably connected to the housing and a second end portion operably connected to the grip member; and
a second plurality of bars, each of the first plurality of bars having a third end portion operably connected to one of the housing and the grip member, and a fourth end portion spaced apart from the other of the housing and the grip member.

16. The power hand tool of claim 15, further comprising:
a plurality of ribs extending outwardly from the housing, each of the plurality of ribs positioned between a respective first and a respective second of the second plurality of bars.

17. The power hand tool of claim 11, further comprising:
a first layer of metal bonded to an inner surface of the at least one elastomer pad; and
a second layer of metal bonded to an outer surface of the at least one elastomer pad.

18. The power hand tool of claim 17, wherein the grip member comprises:
a first clamshell portion configured to mate with a first of the at least one elastomer pads; and
a second clamshell portion configured to mate with the first clamshell portion and with a second of the at least one elastomer pads.

19. The power hand tool of claim 1, further comprising:
an activation button, the activation button configured to selectively couple and decouple the grip member to the housing.

20. The power hand tool of claim 1, further comprising:
at least one lever arm pivotably supported by the grip member and movable between a first position whereat the lever arm compresses the at least one vibration isolation portion by a first amount and a second position whereat the lever arm compresses the at least one vibration isolation portion by a second amount, the second amount less than the first amount.

21. The power hand tool of claim 1, wherein:
the vibration isolation potion is configured such that as the housing moves in the at least one direction from a first position to a second position the at least one isolation portion exhibits a first damping characteristic;
the vibration isolation potion is further configured such that as the housing moves in the at least one direction from the second position to a third position the at least one isolation portion exhibits a second damping characteristic; and
the second damping characteristic is greater than the first damping characteristic.
